(19) United States
(12) Patent Application Publication
(10) Pub. No.: US 2013/0236208 A1
(43) Pub. Date: Sep. 12, 2013

(54) IMAGE FORMING APPARATUS

(71) Applicant: CANON KABUSHIKI KAISHA, TOKYO (JP)

(72) Inventor: Isao Komatsu, Kashiwa-shi (JP)

(73) Assignee: CANON KABUSHIKI KAISHA, TOKYO (JP)

(21) Appl. No.: 13/779,899

(22) Filed: Feb. 28, 2013

(30) Foreign Application Priority Data
Mar. 12, 2012 (JP) 2012-053948

(51) Int. Cl. G03G 15/16; G03G 21/00

(52) U.S. Cl. CPC G03G 15/095
USPC 399/101; 399/350

(57) ABSTRACT

Image forming apparatus includes first cleaning blade for photosensitive drum, wherein the first blade includes first regions and second region with respect to widthwise direction, the first regions being at opposite ends of the first blade, respectively and having first hardness, and the second region being between the first regions and having hardness which is lower than the first hardness; and second cleaning blade for the intermediary transfer member, wherein the second blade includes third regions and fourth region with respect to the widthwise direction, the third regions being at opposite ends of the second blade, respectively and having a second hardness which is the same as or different from the first hardness, and the fourth region being between the third regions and having hardness lower than the second hardness, and wherein the second region is within the fourth region with respect to the widthwise direction.

### FIELD OF THE INVENTION AND RELATED ART

The present invention relates to an image forming apparatus, which employs a pair of cleaning blades, which are hardened across their lengthwise end portions and are placed in contact with the image bearing member and intermediary transferring member (or the like), one for one.

There has been widely used an image forming apparatus which forms a toner image, transfers the toner image onto recording medium with the use of an intermediary transferring member or a recording medium conveying member, and fixes the transferred toner image on the recording medium by applying heat and pressure to the recording medium and the toner image thereon with the use of a fixing device. Such an image forming apparatus employs a cleaning device for recovering transfer residual toner, that is, the toner remaining adhered to the image bearing member and/or intermediary transferring member (or the like) after the transfer of a toner image from the image bearing member and intermediary transferring member. The cleaning device employs an elastic cleaning blade, which is placed in contact with the surface to be cleaned by the cleaning blade, in such an attitude that its cleaning edge is on the upstream side of its base portion in terms of the direction in which the surface to be cleaning by the cleaning blade moves.

In terms of the direction perpendicular to the direction in which a toner image is conveyed, that is, the lengthwise direction of an image bearing member, that is, the widthwise direction of an intermediary transfer member (or the like), the end portions of the image bearing member and those of the intermediary transferring member (or the like) are smaller in the amount of toner thereon than the center portions of the image bearing member and intermediary transferring member, respectively. Therefore, the friction between the end portions of the image bearing member and the cleaning blade is likely to be greater than the friction between the center portion of the image bearing member and the cleaning blade. As the friction between a cleaning blade and the surface to be cleaned by the cleaning blade increases, the cleaning blade increases in the amount by which it is deformed by the surface which is being cleaned by the blade. Thus, Japanese Laid-open Patent Application 2003-122222 proposes to make the end portions of a cleaning blade harder than the center portion of the blade, in order to minimize the amount by which the cleaning blade is possibly deformed by the friction between the lengthwise end portions of the cleaning blade, and the surface to be cleaned by the blade. Further, Japanese Laid-open Patent Application 2009-63993 proposes to make the end portions of a cleaning blade harder than the center portion of the blade in order to make the end portions less in the friction between the cleaning blade and the surface to be cleaned by the cleaning blade than the center portion of the blade.

Both Japanese Laid-open Patent Applications 2003-122222 and 2009-63993 propose to use isocyanate to chemically process the end portions of a cleaning blade in order to increases the end portions in hardness. The chemical process proposed in both patent applications is such a process that coats a component, the entirety of which is formed of rubber, with isocyanate which is a cross-linking agent, across a specific surface area, and heats the component, to the component higher in coefficient of elasticity only across the specific area.

A cleaning blade was formed, in a single piece, of urethane rubber. Then, its lengthwise end portions were processed with isocyanate. Then, the blade was evaluated for its cleaning performance by an experiment in which the blade was mounted in an image forming apparatus of the intermediary transfer type. The results of the experiment revealed that certain combinations, in terms of positional relationship, between the range of the image bearing member, with which the untreated (unhardened) portion of the image bearing member cleaning blade is placed in contact, and the range of the intermediary transfer member, with which the untreated (unhardened) portion of the intermediary transfer member cleaning blade is placed in contact, make it easier for the residual toner to slip by the cleaning devices. For example, in a case where a photosensitive member cleaning blade and an intermediary transfer belt cleaning blade are positioned relative to each other in such a manner that in terms of the lengthwise direction of the photosensitive member (widthwise direction of intermediary transfer belt), the untreated (unhardened) portion (center portion) of the photosensitive member cleaning blade falls within the range of the untreated (unhardened) portion (center portion) of the intermediary transfer belt cleaning blade, the residual toner is more likely to slip by. Further, the greater the amount by which the residual toner slips by the image bearing member cleaning blade, the greater the amount by which the residual toner remains adhered to the intermediary transfer member, and therefore, the lower the image forming apparatus will be in image quality.

Thus, the primary object of the present invention is to provide an image forming apparatus which is optimal in terms of the combination, in terms of positional relationship, between the range across which the untreated (unhardened) portion of the image bearing member cleaning blade is placed in contact with the image bearing member, and the range across which the untreated (unhardened) portion of the intermediary transfer member cleaning blade is placed in contact with the intermediary transfer member, being therefore unlikely to allow the residual toner to escape, and therefore, remains high in image quality for a long time.

### SUMMARY OF THE INVENTION

In an image forming apparatus in accordance with the present invention, as the residual toner on the photosensitive member slips by the first cleaning blade, at the transitional portion between the treated (hardened) portion and untreated (unhardened) portion of the first cleaning blade, it is transferred onto the intermediary transfer member, and then, is scraped away by the untreated (unhardened) portion of the second cleaning blade. The untreated (unhardened) portion of the second cleaning blade is greater in cleaning performance than the treated (hardened) portion of the blade. Therefore, the amount by which residual toner slips by the second cleaning blade, and remains adhered to the intermediary transfer member as the belt is circularly moved, is smaller than that when the relationship is reversal.

Therefore, an image forming apparatus can be increased in image quality by optimizing the combination, in terms of positional relationship in terms of the direction perpendicular to the toner image conveyance direction, between the range across which the untreated (unhardened) portion of the image bearing member cleaning blade is placed in contact with the image bearing member, and the range across which the untreated (unhardened) portion of the intermediary transfer member is placed in contact with the intermediary transfer member, in order to make it difficult for the residual toner on its image bearing member and intermediary transfer member to escape.

According to an aspect of the present invention, there is provided an image forming apparatus comprising a rotatable image bearing member for carrying a toner image; a rotatable intermediary transfer member onto which the toner image is transferred from said image bearing member; a transfer member for transferring the toner image from said intermediary transfer member onto a recording material; a first cleaning blade for cleaning said image bearing member after the toner image is transferred onto said intermediary transfer member, wherein said first cleaning blade includes first regions and a second region with respect to a widthwise direction perpendicular to a rotational moving direction of the image bearing member, said first regions being at opposite end portions of said first cleaning blade, respectively and having a first hardness, and said second region being between said first regions and having a hardness which is lower than the first hardness; and a second cleaning blade for cleaning said intermediary transfer member after the toner image is transferred onto the recording material, wherein said second cleaning blade includes third regions and a fourth region with respect to the widthwise direction, said third regions being at opposite end portions of said second cleaning blade, respectively and having a second hardness which is the same as or different from the first hardness, and said fourth region being between said third regions and having a hardness which is lower than the second hardness, and wherein said second region is within the fourth region with respect to the widthwise direction.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic sectional view of a typical image forming apparatus to which the present invention is applicable. It shows the general structure of the apparatus.

FIG. 2 is a schematic perspective view of a cleaning blade, and an intermediary transfer belt with which the cleaning blade is in contact.

FIG. 3 is a schematic perspective view of the cleaning blade.

FIG. 4 is a schematic sectional view of the cleaning blade, at a plane perpendicular to the lengthwise direction of the blade.

FIG. 5 is an enlarged schematic sectional view of the cleaning edge portion and its adjacencies, of the cleaning blade, at a plane perpendicular to the lengthwise direction of the blade.

FIG. 6 is a schematic drawing for showing the positional relationship between the untreated portion of the photosensitive drum cleaning blade, and the untreated portion of the intermediary transfer belt cleaning blade, of the first comparative image forming apparatus, in terms of the lengthwise direction of the blades.

FIG. 7 is a schematic drawing for describing the positional relationship, in terms of the widthwise direction of the cleaning blades, among the photosensitive drum, charge roller, development roller, drum cleaning blade, and belt cleaning blade of the image forming apparatus in the first embodiment of the present invention.

FIG. 8 is a schematic drawing for describing the positional relationship between the untreated portion of the drum cleaning blade, and the untreated portion of the belt cleaning blade, in terms of the lengthwise direction of the cleaning blades, in the first embodiment of the present invention.

FIG. 9 is a schematic drawing for describing the positional relationship among the untreated portion of the drum cleaning blade of each of the four image formation stations, and the untreated portion of the belt cleaning blade, in terms of the lengthwise direction of the cleaning blades, in the second embodiment of the present invention.

FIG. 10 is a schematic drawing for describing the positional relationship between the treated (hardened) portion of the drum cleaning blade, and the charge roller 2, in the third embodiment of the present invention.

FIG. 11 is a schematic drawing for describing the positional relationship between the treated (hardened) portion of the drum cleaning blade, and the charge roller 2, of the fourth comparative image forming apparatus.

### DESCRIPTION OF THE PREFERRED EMBODIMENTS

Hereinafter, a few of typical embodiments of the present invention are described in detail with reference to the appended drawing. The following embodiments of the present invention are not intended to limit the present invention in scope. That is, the present invention is applicable to any image forming apparatus, even if the apparatus is partially or entirely different in structure from those in the following embodiments, as long as the apparatus is provided with a photosensitive drum cleaning blade, the lengthwise end portions of which are harder than the center portion of the blade, and an intermediary transfer belt (or the like), the lengthwise end portions of which are harder than the center portion of the blade, and the former and latter are placed in contact with the peripheral surface of the photosensitive member, and the image bearing surface of the intermediary transfer belt, respectively.

That is, the present invention is applicable to any image forming apparatus regardless of whether the apparatus is of the tandem or single drum type, of the intermediary transfer or direct transfer (does not have intermediary transfer belt) type, whether the photosensitive member of the apparatus is based on organic photo-conductor, or inorganic photo-conductor such as amorphous silicon, whether the photosensitive member is a photosensitive drum or a photosensitive belt, and also, regardless of charging method, development method, transferring method, cleaning method, and fixing method, as long as the apparatus is structured as described above. Further, the present invention is applicable to any image forming apparatus regardless of whether its developing device uses two-component developer or single component developer, as long as the apparatus is structured as described above. Incidentally, in the following description of the image forming apparatuses in accordance with the present invention, only the portions of the apparatus, which are involved in the formation and transfer of a toner image, are described. However, the present invention is also applicable to an image forming apparatus other than those in the embodiments. For example, it is applicable to various printers, copying machines, facsimile machines, multifunction image forming machines, which are the combinations of one of the image forming apparatuses in the following embodiments, and additional devices, equipment, external shell (casing), etc. which are necessary for them to operate.

### <Image Forming Apparatus>

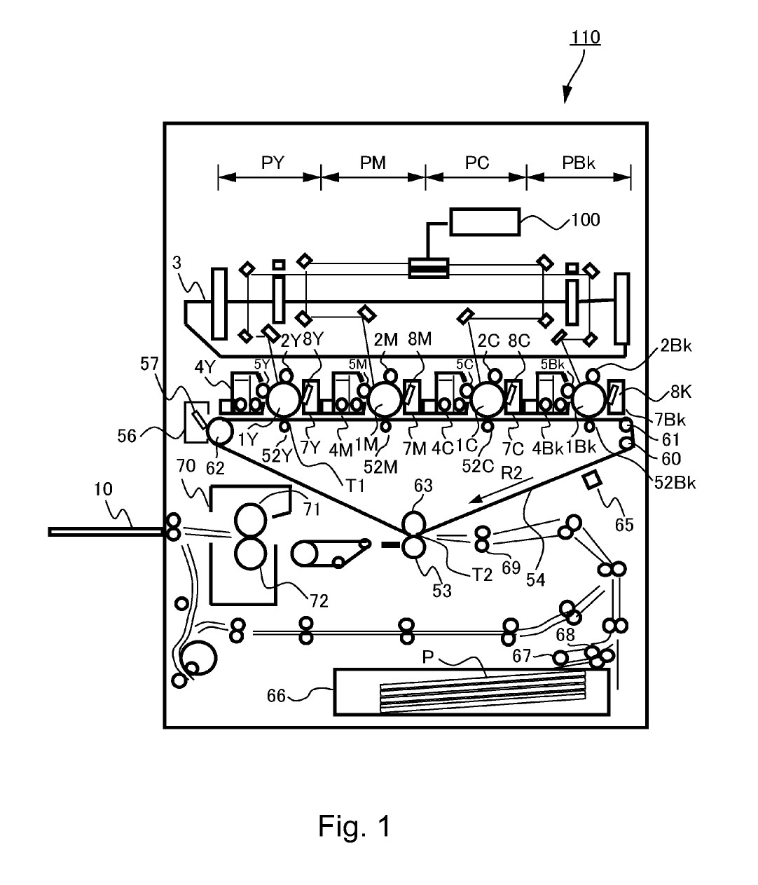

FIG. 1 is a schematic sectional view of a typical image forming apparatus to which the present invention is applicable. It shows the general structure of the apparatus. As is evident from FIG. 1, the image forming apparatus 110 is a full-color printer of the tandem type, and also, of the intermediary transfer type. That is, it has an intermediary transfer belt 54, and yellow, magenta, cyan and black image forming stations PY, PM, PC and PBk, respectively, which are aligned in tandem along the image bearing surface of the intermediary transfer belt 54.

In the image formation station PY, a yellow toner image is formed on a photosensitive drum 1Y, and is transferred onto the intermediary transfer belt 54. In the image formation station PM, a magenta toner image is formed on a photosensitive drum 1M, and is transferred onto the intermediary transfer belt 54. In the image formation stations PC and PBk, cyan and black toner images are formed on the photosensitive drums 1C and 1Bk, respectively, and are transferred onto the intermediary transfer belt 54.

After the transfer of the four toner images, different in color, onto the intermediary transfer belt 54, the toner images are conveyed by the intermediary transfer belt 54, to the secondary transfer station T2, in which they are transferred onto a sheet of recording medium. More specifically, after the four toner images, different in color, are layered on the intermediary transfer belt 54, the four toner images are given a preset amount of electrical charge by a post-charging device, which is a charging device of the corona type. Then, they are conveyed to the secondary transfer station T2.

Meanwhile, a sheet P of recording medium is moved out of a recording medium cassette 66 by a pickup roller 67 while being separated from the rest of the sheets of recording medium in the cassette 66 by separation rollers 68. Then, it is conveyed to a pair of registration roller 69, which convey the sheet P further with such a timing that the sheet P arrives at the secondary transfer station T2 at the same time as the layered toner images on the intermediary transfer belt 54. In the secondary transfer station T2, the toner images on the intermediary transfer belt 54 are transferred together onto the sheet P. Then, the sheet P is sent into a fixing device 70, through which it is conveyed while remaining pinched by the fixation roller 71 and pressure roller 72 of the fixing device 70. While the sheet P is conveyed through the fixing device 70, the sheet P and the toner images thereon are subjected to the heat and pressure from the fixation roller 71 and pressure roller 72. Consequently, the toner images become fixed to the sheet P. Then, the sheet P is discharged into a delivery tray 10.

The image formation stations PY, PM, PC and PBk are roughly the same in structure, although they are different in the color of the toner they use. Therefore, only the image formation station PY is described in order not to repeat the same description, since the descriptions of the image formation stations PM, PC and PBk are the same as that of the image formation station PY, except for the suffixes of their referential codes.

The image formation station PY has a photosensitive drum 1Y. It has also a charge roller 2Y, an exposing device 3, a developing device 4Y, a primary transfer roller 52Y, and a drum cleaning device 7Y, which are positioned in the adjacencies of the peripheral surface of the photosensitive drum 1Y. The photosensitive drum 1Y is made up of an aluminum cylinder, and a negatively chargeable photosensitive layer formed on the peripheral surface of the aluminum cylinder. It is rotated at a preset process speed in the direction indicated by an arrow mark. The charge roller 2Y uniformly charges the peripheral surface of the photosensitive drum 1Y to a preset potential level. The exposing device 3 writes an electrostatic image on the uniformly charged peripheral surface of the photosensitive drum 1, by scanning the uniformly charged peripheral surface of the photosensitive drum 1Y with a beam of laser light which it emits while deflecting the beam with its rotational mirror. The developing device 4Y develops the electrostatic image on the peripheral surface of the photosensitive drum 1Y into a toner image, that is, a visible image formed of toner.

The primary transfer roller 52Y is kept pressed upon the inward surface of the intermediary transfer belt 54 to form the primary transfer station T1 between the peripheral surface of the photosensitive drum 1Y and intermediary transfer belt 54. As positive DC voltage is applied to the primary transfer roller 52Y, the negatively charged toner image on the peripheral surface of the photosensitive drum 1Y is transferred (primary transfer) onto the intermediary transfer belt 54.

### [Charge Roller]

The charge roller 2Y is made up of a metallic shaft, and an electrically conductive elastic cylindrical layer formed on the peripheral surface of the metallic shaft. The charge roller 2Y is kept pressed toward the photosensitive drum 1Y by a pair of springs which press on the lengthwise end portions of the charge roller 2Y. It is rotated by the rotation of the photosensitive drum 1Y. To the charge roller 2Y, oscillatory voltage, which is a combination of DC voltage and AC voltage, is applied. As the oscillatory voltage is applied to the charge roller 2Y, the charge roller 2Y uniformly and negatively charges the peripheral surface of the photosensitive drum 1Y to a preset potential level VD (which corresponds to potential level of unexposed portion of electrostatic image).

### [Developing Device]

The developing device 4Y contains developer, more specifically, a mixture of toner and carrier. The developer in the developing device 4Y is circularly conveyed in the developing device 4Y by a pair of developer conveyance screws, which are opposite in rotational direction, while being stirred by the screws, in the direction perpendicular to the surface of the sheet of paper on which FIG. 1 is present. As the developer is circularly conveyed, while being stirred, by the screws, the toner in the developer becomes negatively charged, whereas the carrier in the developer becomes positively charged. As the developer is conveyed, while being stirred, by the screws, it is borne by a development sleeve 5Y, which rotates around a stationary magnetic roller it holds in its hollow. Then, the developer is carried by the development sleeve 5Y to the development area, which is the area of virtual contact between the peripheral surface of the development sleeve 5Y and the peripheral surface of the photosensitive drum 1Y. As the development sleeve 5Y is rotated, the developer on the development sleeve 5Y is made to crest by the magnetic force of the magnetic pole of the magnetic roller, which is in the development area, forming a magnetic brush. As an oscillating voltage, which is a combination of negative DC voltage, and AC voltage, is applied to the development sleeve 5Y while the peripheral surface of the photosensitive drum 1Y is rubbed by the magnetic brush made of the developer, the toner in the magnetic brush transfers onto the peripheral surface of the photosensitive drum 1Y in the pattern of the electrostatic image on the peripheral surface of the photosensitive drum 1Y; the electrostatic image is developed into a visible image formed of toner.

### [Drum Cleaning Device]

The drum cleaning device 7 has a cleaning blade 8Y, the cleaning edge of which is placed in contact with the peripheral surface of the photosensitive drum 1Y to scrape away, and recover, the transfer residual toner remaining adhered to the immediately downstream portion of the peripheral surface of the photosensitive drum 1Y with respect to the primary transfer station. More specifically, the cleaning blade 8Y is kept pressed upon the peripheral surface of the photosensitive drum 1Y at a preset angle with the application of a preset amount of pressure. As the transfer residual toner is scraped away from the peripheral surface of the photosensitive drum 1Y, it falls into the housing of the drum cleaning device 7Y, and is conveyed by a screw to one of the lengthwise ends of the housing, from which it is discharged into a container for recovered toner.

The cleaning blade 8Y is an elastic blade formed of urethane rubber or the like. It is placed in contact with the peripheral surface of the photosensitive drum 1Y so that its cleaning edge remains in contact with the peripheral surface of the photosensitive drum 1Y. More specifically, it is placed in contact with the peripheral surface of the photosensitive drum 1Y in such an attitude that it becomes parallel to the direction (primary scan direction) which is perpendicular to the direction in which the toner image is conveyed, and also, that its cleaning edge is on the upstream side of its base portion in terms of the rotational direction of the photosensitive drum 1Y. The cleaning blade 8Y forms a cleaning area, where its cleaning edge is kept in contact with the preset range of the peripheral surface of the photosensitive drum 1Y in terms of the lengthwise direction of the photosensitive drum 1Y, by being placed in contact with the peripheral surface of the photosensitive drum 1Y.

### [Intermediary Transfer Belt]

The intermediary transfer belt 54 is suspended by a belt steering roller 60 (steering roller), a belt driving roller 61 (driver roller), a belt tensioning roller 62 (tension roller), and a belt backing roller 63 (backup roller 63). It is circularly moved in the direction indicated by an arrow mark R2 at a preset process speed. The image forming apparatus 110 is structured so that the steering roller 60 can be tilted in an oscillatory manner to move the intermediary transfer belt 54 in an oscillatory manner in the direction perpendicular to the toner image conveyance direction. The intermediary transfer belt 54 in the following embodiments of the present invention is an endless belt formed of polyimide resin. It is 10¹² Ω/□ in surface resistivity, and 100 μm in thickness.

The secondary transfer roller 53 is positioned so that it remains in contact with the outward surface (in terms of loop intermediary transfer belt forms) of the portion of the intermediary transfer belt 54 which is supported by the backup roller 63 from the inward side (in terms of loop intermediary transfer belt forms) of the intermediary transfer belt 54, forming thereby the secondary transfer station T2 between itself and the intermediary transfer belt 54. The backup roller 63 is grounded. During an image forming operation, DC voltage which is opposite in polarity to the polarity of the toner charge is applied to the secondary transfer roller 53, whereby the toner image on the intermediary transfer belt 54 is transferred (secondary transfer) onto a sheet P of recording medium.

### [Belt Cleaning Device]

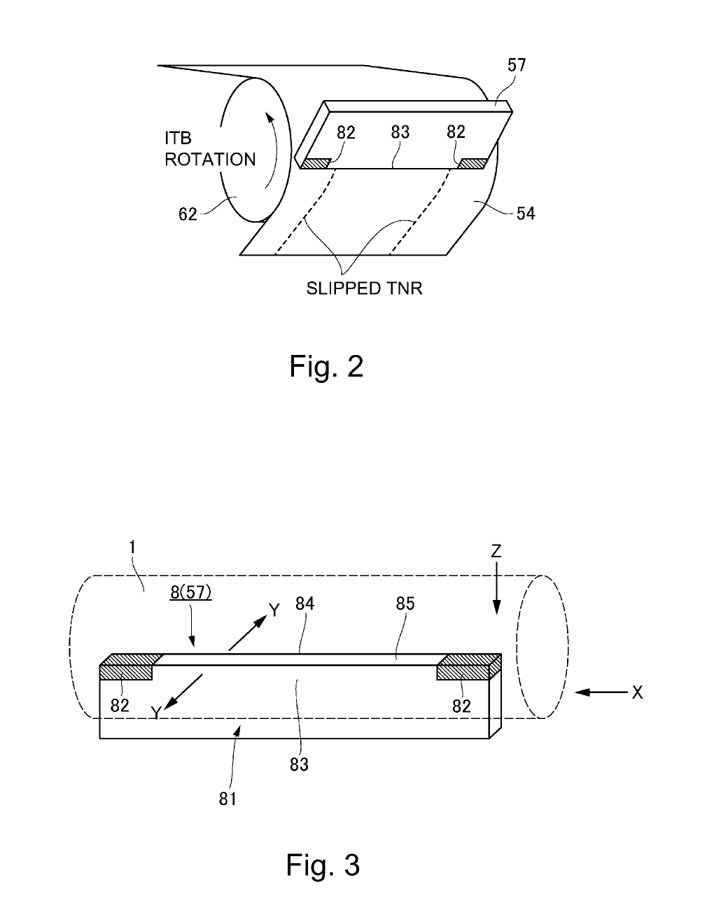

FIG. 2 is a drawing for describing the state of contact between the cleaning blade 57 of the belt cleaning device 56 and the intermediary transfer belt 54. Referring to FIG. 1, the image forming apparatus 110 is provided with the belt cleaning device 56, which is positioned on the downstream side of the secondary transfer station T2 in terms of the moving direction of the intermediary transfer belt 54. The belt cleaning device 56 is roughly the same in structure as the drum cleaning device 7Y. It has the cleaning blade 57, which is placed in contact with the intermediary transfer belt 54 so that its cleaning edge remains in contact with the intermediary transfer belt 54. It removes the transfer residual toner, that is, the toner remaining on the intermediary transfer belt 54, on the downstream side of the secondary transfer station T2, paper dust, and the like, and recovers them. More specifically, as the transfer residual toner, paper dust, etc., are scraped away by the cleaning blade 54, they fall into the housing of the drum cleaning device 56, and are conveyed by a screw to one of the lengthwise ends of the housing, from which they are discharged into a container for the recovered toner.

Referring to FIG. 2, the cleaning blade 57 is an elastic blade formed of urethane rubber or the like. It is placed in contact with the outward surface of the intermediary transfer belt 54 so that its cleaning edge remains in contact with the outward surface of the intermediary transfer belt 54. More specifically, it is placed in contact with the intermediary transfer belt 54 in such an attitude that it becomes parallel to the direction (primary scan direction) which is perpendicular to the direction in which the toner image is conveyed, and also, that its cleaning edge is on the upstream side of its base portion in terms of the moving direction of the intermediary transfer belt 54. The cleaning blade 57 forms a cleaning area, where its cleaning edge is kept in contact with the outward surface (in terms of loop intermediary transfer belt forms) of the portion of the intermediary transfer belt 54 which is supported by the backup roller 63 from the inward side (in terms of loop intermediary transfer belt forms) of the belt 54.

### <Cleaning Blade>

The cleaning blades 8Y, 8M, 8C and 8Bk, are the same in shape, material, function, and like attributes. Hereafter, therefore, they are going to be described as a cleaning blade 8. Accordingly, the structural components of the image forming apparatus shown in FIG. 1, which are related to the cleaning blade 8, are going to be referred to without the suffixes Y, M, C and Bk.

Up to the present time, cleaning blades 8 (8Y, 8M, 8C and 8Bk) and 57 formed of elastic rubber have been widely used as a means for cleaning the photosensitive drum 1, and an intermediary transfer belt 54, more specifically, a means for removing the transfer residual toner and the like contaminants from the photosensitive drum 1 and intermediary transfer belt 54, respectively. As for the elastic material for the cleaning blades 8 and 57, urethane rubber is the mainstream substance because it is highly elastic and highly resistant to abrasion, and also, is mechanically strong, and resistant to oil, ozone, etc.

Referring to FIG. 2, in a case where the cleaning blade 57 is formed of urethane rubber, the lubricity between the intermediary transfer belt 54 and cleaning blade 57 is maintained primarily by toner and the external additives of toner. However, the lengthwise end portions of the cleaning blade 57 in terms of the direction perpendicular to the toner image conveyance direction coincide with the margin portions of a print. That is, they coincide with the portions of the peripheral surface of the photosensitive drum 1 (1Y, 1M, 1C and 1Bk, shown in FIG. 1), across which no toner image is formed. Further, no toner image, or no part of a toner image, is formed on the end portions of the photosensitive drum 1 in terms of the lengthwise direction of the photosensitive drum 1. Therefore, there is little chance that toner and the external toner additives adhere to the end portions of the photosensitive drum 1, and/or the edge portions of the intermediary transfer belt 54. Therefore, the amount of the toner which reaches the cleaning blades 8 and 57 is extremely small.

Therefore, it is difficult for the lubricity to be satisfactorily maintained between the cleaning blade 8 and the peripheral surface of the photosensitive drum 1, and between the cleaning blade 57 and intermediary transfer belt 54. Therefore, as the photosensitive drum 1 is rotated, the lengthwise end portions of the cleaning edge of the cleaning blade 8 are dragged downstream, in terms of the rotational direction of the photosensitive drum 1, by a substantial distance relative to the center portion of the cleaning blade 8, which is supplely supplied with toner. Thus, the cleaning blade 8 is deformed, being thereby reduced in the length of its life, and/or is likely to allow toner to slip by. Further, as the intermediary transfer belt 57 is circularly moved, the cleaning edge portion of the cleaning blade 57 is dragged downstream, in terms of the moving direction of the intermediary transfer belt 54, by a substantial distance relative to the center portion of the cleaning blade 57, which is supplely supplied with toner. Thus, the cleaning blade 57 is deformed, being reduced in the length of its life and/or allowing toner to slip by.

One of the methods for minimizing the amount of the deformation of the lengthwise end portions of a cleaning blade, which is attributable to the lack of toner as lubricant, is to harden the lengthwise end portions of the cleaning edge of the cleaning blade, in order to reduce the friction between them and the surface to be cleaned. In the case of the cleaning blades 8 and 57 in the following embodiments of the present invention, the lengthwise end portions of the cleaning edge portion of the elastic rubber portion of the cleaning blade is coated (soaked) with isocyanate so that they will increase in hardness by cross-linking.

### [Manufacturing of Cleaning Blade]

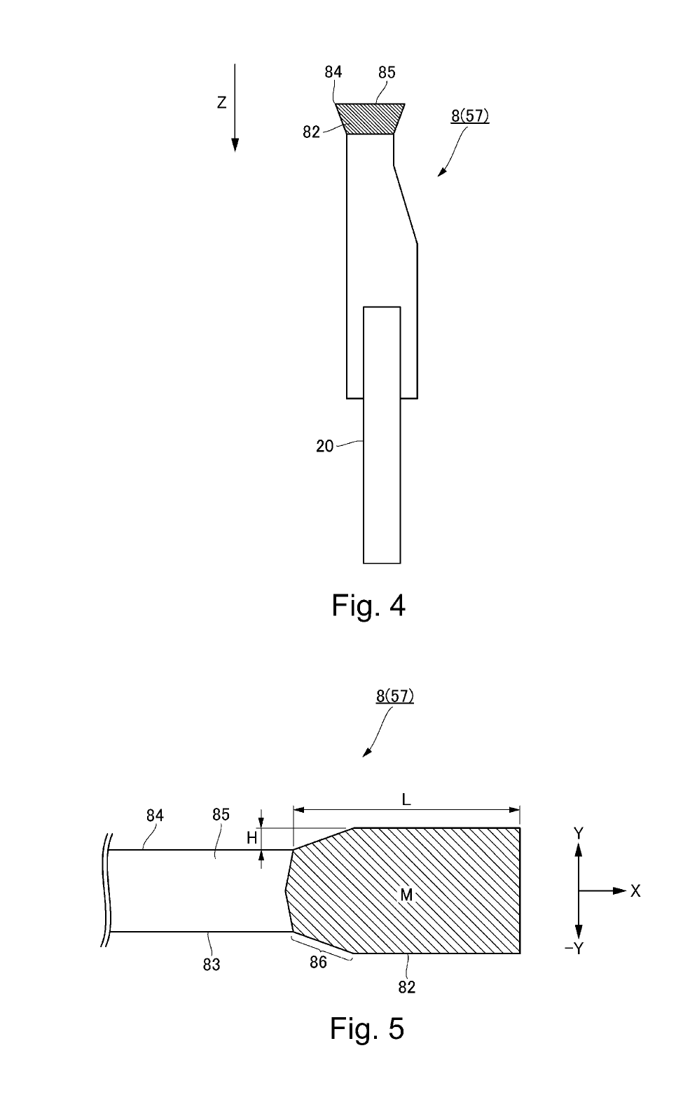

FIG. 3 is a schematic perspective view of the cleaning blade. FIG. 4 is a schematic sectional view of the cleaning blade. FIG. 5 is an enlarged schematic side view of the cleaning edge portion of the cleaning blade.

Referring to FIG. 4, the cleaning blades 8 and 57 are made up of a metallic supporting member 20, and a blade portion 81 molded of urethane rubber in such a manner that it remains firmly attached to the metallic supporting member 20. More specifically, the elastic portion 81 is formed by allowing a mixture of polyisocyanate compound and multifunctional active hydrogen compound to cross-link in a metallic mold in which the supporting member 20 is positioned.

As the polyisocyanate compound, prepolymer and semi-prepolymer obtainable by making ordinary polyisocyanate with high-molecular polyol which is a multifunctional active hydrogen compound is desirable. For the purpose of obtaining a cleaning blade, the elastic portion 81 of which is excellent in elasticity, the amount (NCO %) of the prepolymer or semi-prepolymer is desired to be in a range of 5-20% in mass. Here, “isocyanate contents (NCO %)” means the amount (in mass) of the functional isocyanate group (NCO, which is assumed to be 42 in molecular weight) in the prepolymer or semi-prepolymer as the material for polyurethane.

Examples of polyisocyanate which are ordinarily used to adjust the prepolymer or semi-prepolymer are: diphenyl-methane-diisocyanate (MDI), tolylene-diisocyanate (TDI), naphthalene-diisocyanate (NDI), hexamethylene-diisocyanate (HDI), etc. Examples of high-molecular polyol, which is the active hydrogen compound for adjusting the prepolymer or semi-prepolymer, are: polyester-polyol, polyether-polyol, caprolactam-ester-polyol, polycarbonate-ester-polyol, silicone-polyol, etc. These high-molecular polyols are desired to be in a range of 500-5,000 in weight average molecular weight.

Examples of cross-linking agent are: 1,4-butanediol, 1,6-hexanediol, ethyleneglycol, trimethylol-propane, etc. Incidentally, sometimes, ordinary catalyst used for yielding polyurethane resin is used to make a combination of polyisocyanate compound, high-molecular polyol, polyisocyanate, and cross-linking agent react. Examples of the ordinary catalyst are triethylene-diamine, and the like.

The elastic portion 81 of the cleaning blade 8 is formed by causing the aforementioned ingredients to turn into polyurethane in the metallic mold. More specifically, high-molecular polyol, polyisocyanate, cross-linking agent, catalyst, etc., are mixed all at once, and the mixture is poured into the metallic mold in which the supporting portion 20 is positioned. In the following embodiments of the present invention, the elastic portion 81 is formed of polyurethane, directly on the supporting portion 20. After the formation of the elastic portion 81, it is cut across its cleaning edge portion, and polished, in order to make precise the cleaning edge, that is, the portion of the cleaning blade 8, which contacts the peripheral surface of the photosensitive drum 1.

Incidentally, the cleaning blade 8 may be formed with the use of a method other than the above described one. For example, such a method that a plate of rubber, the thickness of which is the same as that of the elastic portion 81 of the cleaning blade 8, is cut into pieces, which are equal in size to the elastic portion 81; and the supporting portion 20 is attached to one of the surfaces of the thus obtained rubber piece with the use of adhesive.

### [Hardening Process]

Referring to FIG. 3, the cleaning blade 8 (57) molded of polyurethane resin is hardened only across the lengthwise end portions of the cleaning edge portion of the elastic portion 81, to create hardened portions 82. The portion of the cleaning edge portion of the elastic portion 81, which are between the hardened portions 82, is left untreated (unhardened), remaining as soft and elastic as the elastic rubber of which it is formed. Hereafter, this center portion of the cleaning edge of the elastic portion 81 of the cleaning blade 8 (57) will be referred to as “untreated (unhardened) portion 83” of the cleaning blade 8 (57). That is, the cleaning edge portion are provided with two treated (hardened) portion 82, which are at the lengthwise ends of the cleaning blade 8 (57), one for one. The resultant cleaning blade 8 (57) is flat and smooth across its surfaces, and the lengthwise end portions 82 of its cleaning edge portion are harder than the center portion 83 of the cleaning edge in terms of the lengthwise direction of the cleaning blade 8 (57). In FIG. 3, the direction indicated by an arrow mark X is the lengthwise direction of the cleaning blade 8 (57), and the direction indicated by an arrow mark Y is the thickness direction of the cleaning blade 8 (57). Further, the direction indicated by an arrow mark Z is the direction in which the peripheral surface of the photosensitive drum 1 moves (intermediary transfer belt 54 moves).

Referring to FIG. 4, the lengthwise end portions of the cleaning edge portion of the cleaning blade 8 (57) were coated with cross-linking agent so that the cross-linking agent hardens the surface layer of the lengthwise end portion by permeating into the lengthwise ends, in the direction indicated by the arrow mark Z. As the cross-linking agent permeates into the lengthwise end portions of the cleaning edge, the lengthwise end portions of the cleaning edge swell in such a manner that the closer to the cleaning edge, the thicker.

Next, referring to FIG. 5, as the cross-linking agent permeates into the lengthwise end portions of the cleaning edge portion of the cleaning blade 8 (57), the lengthwise end portions increase in thickness, becoming therefore different in thickness from the center portion (untreated) 83. Consequently, the portion of the cleaning edge portion, which is between the treated (hardened) portion 82 and unhardened portion 83, becomes insufficient in the contact pressure between itself and the peripheral surface of the photosensitive drum 1 (outward surface of intermediary transfer belt 54), making it easier for the residual toner to slip by the cleaning blade.

The process for turning each of the lengthwise end portions of the cleaning edge portion of the cleaning blade 8 (57) into the “hardened portion 83” is as follows:

Step 1: isocyanate compound is placed in contact with the cleaning blade 8 (57) across the preset lengthwise end portions of the cleaning edge portion (which is to be placed in contact with photosensitive drum 1 (intermediary transfer belt 57)).

Step 2: cleaning blade 8 (57) is left unattended, with the isocyanate compound being left on the surface of the cleaning blade 8 (57), so that the isocyanate compound permeates into the cleaning blade (57) across the lengthwise end portions of the cleaning edge portions, by a proper amount.

Step 3: isocyanate compound remaining on the surface of the cleaning blade 8 (57) is removed after its permeation into the cleaning blade 8 (57); excessive isocyanate compound is removed from the surface of the cleaning blade 8 (57).

Step 4: isocyanate compound having permeated into the cleaning blade 8 (57) reacts with the polyurethane resin to harden the lengthwise end portions of the cleaning edge portion of the cleaning blade 8 (57) to create the hardened portions 82. More specifically, polyurethane resin of which the cleaning blade 8 (57) is formed reacts with isocyanate compound, forming thereby allophanate bond between them, which hardens the polyurethane, increasing thereby the lengthwise end portions of the elastic portion of the cleaning blade 8 (57) in coefficient of elasticity and rigidity. Consequently, the lengthwise end portions of the cleaning edge portion of the cleaning blade 8 (57) reduces in coefficient of friction, which in turn improves in durability the cleaning blade 8 (57).

That is, polyurethane resin, of which the cleaning blade 8 (57) is formed, has urethane bond having active hydrogen. It is thought that in Step 4, this urethane bond forms allophanate bond by reacting with the isocyanate having permeated into the elastic portion 81 of the cleaning blade 8, and therefore, the lengthwise end portions (82) of the cleaning edge portion of the cleaning blade 8 (57) harden. It is also thought that polymerization (formation of carbodiimide, isocyanurate, and the like) of isocyanate compound itself, which occurs at the same time as the formation of allophanate bond, also contributes to the hardening of the lengthwise end portions 82. It is also thought that virtually the entirety of isocyanate compound remaining on the surface of the cleaning blade 8 (57) reacts with the moisture in the air, and leaves a hard surface layer, which is white and opaque, on the surface of the cleaning blade 8 (57).

The isocyanate compound which is made to permeates the elastic portion 81 of the cleaning blade (57) may be such isocyanate compound that has one isocyanate radical per molecule, or such isocyanate that has two or more isocyanate radicals per molecule. Examples of isocyanate compound having a single isocyanate radical per molecule are: aliphatic monoisocyanate (such as octadecileisocyanate (ODI)), aromatic monoisocyanate, and the like. Examples of isocyanate compound having two or more isocyanate radical are 2,4-tolylenediisocyante, 2,6-tolylenediisocyanate, 4,4′-diphenylmethane-diisocyanate (MDI), m-phenylenediisocyanate, tetramethylene-diisocyante, hexamethylene-diisocyanate, and the like.

For the purpose of accelerating the reaction of isocyanate compound with polyurethane resin, it is desired that not only the isocyanate compound, but also, catalyst is made to permeate the polyurethane resin. Examples of catalyst usable with the isocyanate compound are: quaternary ammonium salt, carboxylate, and the like. Examples of quaternary ammonium salt are potassium acetate, potassium octylate, and the like. These catalysts are highly viscous, or solid. Therefore, it is desired that they are dissolved in solvent in advance and mixed into isocarbonate so that they permeate the polyurethane resin with the isocyanate.

Step 1, which is for placing the lengthwise end portions of the cleaning edge portion of the elastic portion of the cleaning blade 8 (57), may be replaced with a method that coats the cleaning blade 8 (57) with a fibrous or porous applicator soaked with isocyanate compound, or a method that sprays isocyanate onto the cleaning blade 8 (57). The cleaning blade 8 and cleaning blade 57 may be different in their areas to be coated with isocyanate.

The length of time isocyanate is allowed to permeate the cleaning blade 8 (57) in Step 2 may be adjusted according to the specifications of the image forming apparatus, and the type of the cleaning blade to be coated with the isocyanate compound. In order to ensure that the lengthwise end portions of the cleaning edge portion of the cleaning blade 8 (57) are properly treated so that the resultant hard portions 82 will be in a proper range in terms of hardness, the length of time the isocyanate compound is to be left on the cleaning blade 8 (57) is desired to be no less than 5 minutes, preferably, no less than 10 minutes. However, it is desired to be no more than an hour. In consideration of productivity, it is desired to be no more than 40 minutes.

Regarding Step 3 for wiping isocyanate compound away from the cleaning blade 8 (57), it is desired that the isocyanate having adhered to the surface of the cleaning blade 8 (57) is completely removed with the used of such solvent that can dissolve isocyanate compound. If the isocyanate compound remaining on the surface of the cleaning blade 8 (57) is not completely removed, that is, if it remains across certain areas of the lengthwise end portions (82) of the cleaning edge portion of the cleaning blade 8 (57), the remaining isocyanate compound makes the lengthwise end portions (82) of the cleaning edge microscopically rough; microscopic peaks and valleys (through which residual toner can escape) are created across the cleaning edge of the lengthwise end portions (hardened portions 82). That is, the cleaning blade 8 (57) is reduced in cleaning performance. As for examples of the solvent to be used for wiping the cleaning blade 8 (57), toluene, xylene, butyl acetate, methyl-ethyl-ketone, and the like can be listed. As for the tools for wiping away isocyanate compound, a piece of sponge formed of polyurethane resin, can be listed; the cleaning blade surface can be wiped with a piece of sponge soaked with a small amount of solvent.

[Swelling Caused to Lengthwise End Portions of Cleaning Edge of Cleaning Blade by Isocyanate Permeation]

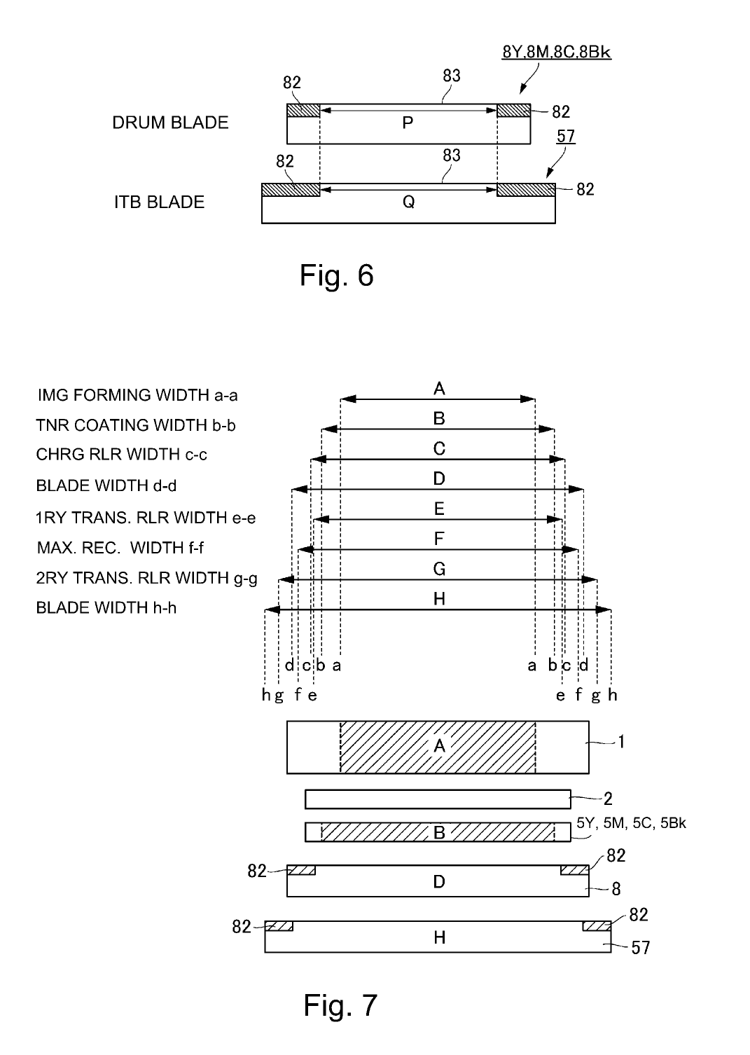

FIG. 6 is a schematic plan view of the cleaning blades 8 (8Y, 8M, 8C and 8Bk) and 57 of the first comparative image forming apparatus. It shows the positional relationship between the untreated portion of the cleaning blade 8 and that of the cleaning blade 57. Referring to FIG. 5, as the lengthwise end portions of the cleaning edge portion of the cleaning blade 8 (57) are treated with isocyanate compound, they swell in their thickness direction (indicated by arrow mark Y); as isocyanate compound permeates into the lengthwise end portions of the cleaning edge, the lengthwise end portions of the cleaning edge swell. In terms of the thickness direction of the cleaning blade 8 (57), the amount H of swelling equals the distance between the cleaning edge 84 of the untreated (unhardened) portion 83 and the cleaning edge 84 of the treated (hardened) portion 82. In terms of the lengthwise direction of the cleaning blade 8 (57), the dimension L of the treated (hardened) portion of the cleaning blade 8 (57) equals the distance between the lengthwise end of the cleaning blade 8 (57) and the “border” between the untreated (unhardened) portion 83 and treated (hardened) portion 82. More specifically, there is a thickness-wise transitional portion 86 where the thickness gradually reduces toward the center of the cleaning blade 8 (57), between the fully swollen portion of the treated (hardened) portion and the untreated (unhardened) portion. Here, the portion of the cleaning edge portion of the cleaning blade 8 (57), where the thickness of the cleaning blade 8 (57) gradually reduces from 90% of the fully swollen portion to 10%, is defined as the thickness-wise transitional area 86, or simply transitional area 86.

As isocyanate compound is allowed to permeate into a given portion of the cleaning blade formed of urethane resin, the given portion swells. Therefore, if the entirety of the cleaning edge portion of the cleaning blade 8 (57) is treated with isocyanate compound, the cleaning edge 84 (by which cleaning blade contacts photosensitive drum or intermediary transfer belt) become wavy. If the portions of the cleaning edge which became wavy happen to coincide with the portions of the cleaning edge, which are likely to encounter a large amount of transfer residual toner, it is possible that toner and/or external additives will slip by the cleaning blade.

According to the present invention, however, isocyanate compound is allowed to permeate into only the lengthwise end portion of the cleaning edge portion of the cleaning blade 8 (57). Therefore, the cleaning edge 84 (which contacts drum or intermediary transfer belt) does not become wavy. However, the lengthwise end portions of the cleaning edge 84 are in contact with the areas of the photosensitive drum 1, across which no image is formed. Thus, the friction between them and the surface to be cleaned by them is greater than the friction between the center portion (unhardened) portion of the cleaning edge 84, and the surface to be cleaned. Therefore, in order to prevent the lengthwise end portions of the cleaning edge 84 of the cleaning blade 8 (57) from being deformed, the lengthwise end portion of the cleaning edge portion of the cleaning blade 8 has to be made sufficiently higher in hardness than the center portion (untreated portion) of the cleaning edge portion of the cleaning blade 8, which is smaller in friction.

However, if the process for treating the lengthwise end portions 82 of the cleaning blade 8 with isocyanate compound is intensified to raise the level to which the lengthwise end portion 82 is to be hardened, the lengthwise end portions 82 swell more. Thus, as the cleaning edge of the cleaning blade 8 is placed in contact with the peripheral surface of the photosensitive drum 1, there will be a gap between the peripheral surface of the photosensitive drum 1 and the transitional portion 86 of the cleaning blade, which is between the untreated portion 83 and treated portion (hardened portion) 82 of the cleaning blade 83. Thus, toner sometimes slips by the cleaning blade 8 through the gap. In the case of the image forming apparatus 110, toner slips by the cleaning blade 8 (8Y, 8M, 8C and 8Bk) little by little, and is transferred onto the intermediary transfer belt 54, accumulating thereon, during sheet intervals and/or idling. If such residual toner on the intermediary transfer belt 54 happens to be transferred onto a sheet of recording medium, it will be visible as image defects.

Referring to FIG. 6, in the case of the first comparative image forming apparatus, the residual toner which slipped by the cleaning blade 8 (8Y, 8M, 8C and 8Bk) and was transferred onto the intermediary transfer belt (54) can be removed by the cleaning blade 57. However, the lengthwise end portions 82 of the cleaning edge of the cleaning blade 57 were hardened, and therefore, are less effective in cleaning performance than the center portion. Thus, the lengthwise portions 82 of the cleaning blade 57 cannot fully remove the residual toner on the intermediary transfer belt 54. That is, if the dimension P of the center portion (untreated portion) of the cleaning edge portion of the cleaning blade 8 is the same as the dimension Q of the center portion (untreated portion) of the cleaning blade 57, and therefore, the transitional portion between the lengthwise end portion 82 and center portion 83 of the cleaning blade 8 overlaps with the transitional portion between the lengthwise end portion 82 and center portion 82 of the cleaning blade 57, in terms of the direction in which the intermediary transfer belt 54 moves, it is very difficult for the cleaning blade 57 to remove the residual toner having transferred from the photosensitive drum onto the intermediary transfer belt 57.

Further, in the case of the image forming apparatus 110, it is possible that the residual toner having slipped by the cleaning blade 8 (8Y, 8M, 8C and 8Bk) will transfer onto the peripheral surface of the charge roller 2 (2Y, 2M, 2C and 2Bk), and accumulate thereon. The accumulation of the residual toner on the peripheral surface of the charge roller 2 prevents the charge roller 2 from normally contacting the peripheral surface of the photosensitive drum 1. Thus, it is possible that the portion of the peripheral surface of the photosensitive drum 1, which corresponds in position to the aforementioned transitional portion (“border”) between the untreated portion 83 and treated portion 82 (hardened portion), will be unsatisfactorily charged.

Thus, in the following embodiments of the present invention, the image forming apparatus 110 is optimized in the positional relationship, in terms of the lengthwise direction of the cleaning blades, between the untreated portion 83 of the cleaning blade 8 and the untreated portion 83 of the cleaning blade 57, in order to prevent the image forming apparatus 110 from outputting a defective image, the defectiveness of which is attributable to the problem that the residual toner slips by the cleaning blade 8 at the transitional portion (“border”) between the treated portion 82 and untreated portion 83 of the cleaning blade 8.

### Embodiment 1

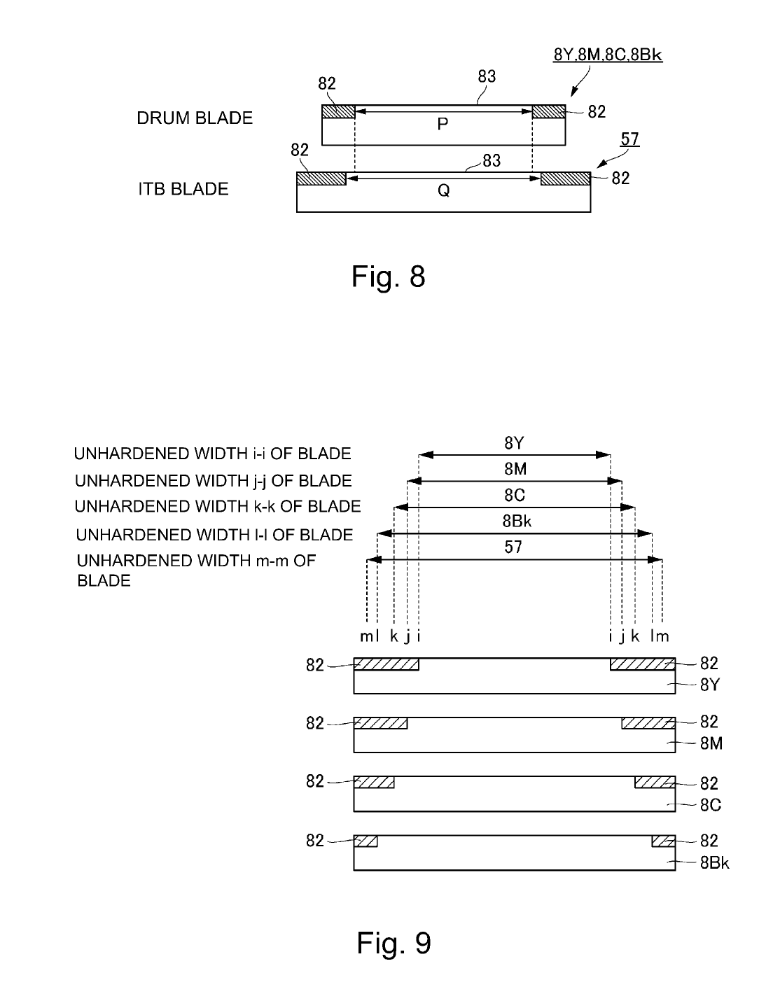

FIG. 7 is a schematic drawing for describing the positional relationship among the cleaning blades 8, charge roller 2, and their various portions (untreated and treated portions, transitional portions, etc.), in the first embodiment of the present invention, in terms of the lengthwise direction of the cleaning blade 8 (charge roller 2). FIG. 8 is a schematic drawing for describing the positional relationship between the untreated portion 83 of the cleaning blade 8, and the untreated portion 83 of the cleaning blade 57, in terms of the lengthwise direction of the blades 8 and 57.

Referring to FIG. 1, the intermediary transfer belt 54 which is an example of an intermediary transfer member is placed in contact with the peripheral surface of the photosensitive drum 1 in the primary transfer station T1, in which the toner image on the peripheral surface of the photosensitive drum 1 is transferred onto the intermediary transfer belt 54. The drum cleaning device 7 which is an example of the first cleaning device has the first cleaning blade (8), the end portions of which in terms of the direction perpendicular to the toner image conveyance direction are harder than its center portion, and which is placed in contact with the peripheral surface of the photosensitive drum 1, on the downstream side of the primary transfer station T2 in terms of the rotational direction of the photosensitive drum 1. The secondary transfer roller 53, which is an example of a toner image transferring mean, transfers the toner image on the intermediary transfer belt 54 onto a sheet of recording medium, by subjecting the intermediary transfer belt 54 to the electrical field which it generates.

The belt cleaning device 56 which is an example of the second cleaning device has the second cleaning blade (57), the end portions of which in terms of the direction perpendicular to the toner image conveyance direction are harder than its center portion, and which is placed in contact with the intermediary transfer belt 54, on the downstream side of the secondary transfer station T2, in terms of the moving direction of the intermediary transfer belt 54. The cleaning blade 8 is a one-piece blade formed of elastic rubber, and so is the cleaning blade 57. They were coated with isocyanate compound (cross-linking agent), across the lengthwise end portions of their cleaning edge portion, and were heated. Thus, the lengthwise end portions of their cleaning edge portion are thicker (swollen) and harder than the center portion of their cleaning edge portion.

Referring to FIG. 7, the cleaning blades 8 and 57 are positioned relative to each other in such a manner than in terms of the lengthwise direction of the cleaning blades 8 and 57, the center portion, that is, the unhardened portion, of the cleaning blade 8 falls within the range of the center portion, that is, the unhardened portion, of the cleaning blade 57. The developing device 4 develops the electrostatic image formed on the photosensitive drum 1Y. The development range of the developing device 4Y in terms of the lengthwise direction of the cleaning blades 8 and 57 falls within the range of the unhardened portion of the cleaning blade 8. The charge roller 2Y is placed in contact with the photosensitive drum 1, and a preset voltage is applied to the charge roller 2Y. Also in terms of the lengthwise direction of the cleaning blades 8 and 57, the entire range of contact between the charge roller 2Y and photosensitive drum 1Y falls within the range of the unhardened portion of the cleaning blade 8.

In terms of the direction perpendicular to the toner image conveyance direction, the photosensitive drum 1 is provided with an image formation range A, that is, a range across which an image can be formed. A referential code a in FIG. 7 stands for the edge of this image formation range A.

Also in terms of the direction perpendicular to the toner image conveyance direction, the development sleeve 5 is provided with a toner (developer) bearing range B, which is wide enough to supply the entirety of the image formation range A of the photosensitive drum 1 to develop the electrostatic image on the image formation range A. A referential code b in FIG. 7 stands for the edge of the toner bearing range B.

The image forming apparatus 110 is structured so that in terms of the lengthwise direction of the cleaning blades 8 and 57, the dimension of the charge roller 2 is made greater than that of the toner bearing range B, in order to prevent toner from adhering to the photosensitive drum 1, outside the toner bearing range B. The length of the charge roller 2 is the same as the dimension of the charging range C, in which the photosensitive drum 1 is chargeable by the charge roller 2. A referential code c stands for the edge of the charging range C.

The dimension D of the cleaning blade 8 in terms of its lengthwise direction is greater than the dimension of the charging range C, for the reason that it is possible that toner might adhere to the portions of the charging range C, which are outside the toner bearing range B, although only by a very small amount. Therefore, the cleaning blade 8 is made long enough to cover the charging range C in terms of the direction parallel to the axial line of the photosensitive drum 1. A referential code d stands for the lengthwise end of the cleaning blade 8. The lengthwise end portions of the cleaning blade 8 have the portions of the cleaning edge portion, into which the isocyanate compound was allowed to permeate. That is, they have hardened cleaning edge portions.

The primary transfer roller 5 is for transferring the toner image (electrostatic image developed in toner bearing range B) onto the intermediary transfer belt 54. Thus, the dimension E of the primary transfer roller 5 in terms of its lengthwise direction is made large enough to cover the entirety of the toner bearing range B of the development roller 5. The dimension E of the primary transfer roller 5 in terms of its lengthwise direction corresponds to the primary transfer range. The referential code e in FIG. 7 stands for the end of the primary transfer roller 5.

The width F of the largest sheet of recording medium conveyable through the image forming apparatus 110 equals the dimension of the recording medium passage of the image forming apparatus, in terms of the direction perpendicular to the recording medium conveyance direction. The edge of the passage is indicated by a referential code f in FIG. 7. The secondary transfer roller 53 has to be enabled to nip even the largest (widest) sheet of recording medium usable by (conveyable through) the image forming apparatus 110. Thus, the dimension G of the secondary transfer roller 53 in terms of its lengthwise direction is made greater than the width F of the largest sheet of recording medium. The dimension G of the secondary transfer roller 53 corresponds to the dimension of the secondary transfer area. The lengthwise end of the secondary transfer roller 53 is indicated by a referential code g in FIG. 7.

The cleaning blade 57 has to remove the transfer residual toner on the intermediary transfer belt 54 across the entire range of the intermediary transfer belt 54 in terms of the widthwise direction of the intermediary transfer belt 54, in order to prevent the transfer residual toner on the intermediary transfer belt 54 from adhering to the secondary transfer roller 53. The dimension H of the cleaning blade 57 is large enough to cover the entirety range of the secondary transfer roller 53 in terms of the lengthwise direction of the secondary transfer roller 53. The lengthwise end of the cleaning blade 57 is indicated by a referential code h. The lengthwise end portions of the cleaning blade 57 have the treated (hardened) portions 82 of its cleaning edge portion, that is, the portions of the cleaning blade 57, into which isocyanate compound was allowed to permeate.

In the first embodiment, the cleaning blades 57 and 8 are different in length (D, H) from each other, but are the same in the dimension L of the treated (hardened) portion 82, which is 6 mm. They both were formed by the same method described above. In the first embodiment, the width a-a of the image formation range A is 305 mm, the width b-b of the toner bearing range B is 315 mm. The width c-c of the charging range C is 319 mm, and the width e-e of the primary transfer roller 5 is 316 mm, and the width f-f of the path of the largest (widest) sheet of recording medium is 320 mm. Lastly, the width g-g of the secondary transfer roller 53 is 330 mm.

Also in the first embodiment, the width d-d of the cleaning blade 8 of the drum cleaning device 7 is 327 mm, and the width h-h of the cleaning blade 57 of the belt cleaning device 56 is 338 mm. The small amount of toner which slipped by the cleaning blade 8 at the transitional portion between the treated (hardened) portions 82 and untreated (unhardened) portion 83 of the cleaning blade 8, and was transferred onto the intermediary transfer belt 54, is conveyed to the untreated (unhardened) portion 83 of the cleaning blade 57. Therefore, it is possible to prevent the formation of a defective image, the defects of which are attributable to the toner adhesion to the intermediary transfer belt 54.

Referring to FIG. 5, in order to ensure that the end portions of the cleaning blades 8 and 57 are hardened enough for them to be prevented from deforming, the end portion of the cleaning blades 8 and 57, which are 6 mm in length L, were treated (hardened) with isocyanate for 40 minutes. The resultant hardened end portion 82 was thicker by 35 μm (amount of swelling) than the unhardened portion 83.

Referring to FIG. 8, in the first embodiment, the untreated (unhardened) portion (P) of the cleaning blade 8 falls within the range of the untreated (unhardened) portion (Q) of the cleaning blade 57, in terms of the lengthwise direction of the cleaning blades 8 and 57. Therefore, the transitional portions between the treated (hardened) and untreated (unhardened) portions 82 and 83 of the cleaning blade 8 do not align with the transitional portion between the treated (hardened) and untreated (unhardened) portions 82 and 83 of the cleaning blade 57, in terms of the moving direction of the intermediary transfer belt 54.

### [Experiment for Evaluating Image Forming Apparatuses for Residual Toner Removal Performance]

The image forming apparatus (cleaning devices) in the first embodiment were evaluated for the buckling of the cleaning blades 8 and 57, and also, for cleaning performance. “Blade buckling” is a phenomenon that in a case where a cleaning blade is placed in contact with a surface to be cleaned by the blade, in such an attitude that its cleaning edge is on the upstream side of the its base portion, in terms of the moving direction of the surface to be cleaned, the cleaning edge portion of the cleaning blade buckles downstream by being dragged by the surface to be cleaned. The experiment for evaluating the image forming apparatuses (cleaning devices) for “blade buckling” was carried out under the high temperature-high humidity condition (32.5° C., and 80%), which is very sever condition with respect to “blade buckling”. The experiment for evaluating the image forming apparatus (cleaning device) for cleaning performance (residual toner removal performance) was carried out in the low temperature-low humidity condition (15° C., 10%), which is a very sever condition in terms of cleaning.

The evaluation was made with the use of a multifunction image forming apparatus iRC 3380 (product of Canon Co., Ltd.). In the experiment, 150,000 copies of an image which is 5% in image ratio were continuously outputted under each of the above described conditions, with the use of the image forming apparatus in the first embodiment, and three comparative image forming apparatuses, which are different in the positioning and specifications of the cleaning blades 8 and 57.

During the early stage of the usage of the cleaning blades 8 and 57, the cleaning blade 8 had not been supplied with toner. Thus, the friction between the untreated portion 83 of the cleaning blade 8 and the photosensitive drum 1 was substantial. Therefore, it was possible that the cleaning edge portion of the cleaning blade 8 would be buckled downstream in terms of the rotational direction of the photosensitive drum 1. Therefore, lubricant was applied to the cleaning blades 8 and 57 across the entirety of their cleaning edge portions, before the experiment was started. The lubricant was a mixture of fluorinated graphite (Cefbon (commercial name): product of Central Glass Co., Ltd.) and hydrofluoroether (HFE); fluorinated graphite, which was 3 μm in average particle diameter was dispersed by 10% in weight in hydrofluoroether as solvent. After the coating of the cleaning blades 8 and 57 with the lubricant, the blades 8 and 57 were dried in an oven to make the solvent to evaporate away.

The results of the experiment for evaluating the image forming apparatus in terms of the buckling of the cleaning blades 8 and 57, and residual toner removal performance, are given in Table 1:

TABLE 1

| | | Comp. | Comp. | Comp. |
|---|---|---|---|---|
| | Emb. 1 | Ex. 1 | Ex. 2 | Ex. 3 |
| Relation between | Blade 8 < | Blade 8 = | Blade 8 > | Blade 8 > |
| blade 8 and blade 57 | Blade 57 | Blade 57 | Blade 57 | Blade 57 |
| in non-treated widths | | | | |
| Swelling width of | 35 | 35 | 35 | 35 |
| blade 8 (micron) | | | | |
| Swelling width of | 35 | 35 | 35 | 15 |
| blade 57 (micron) | | | | |
| Prevention of | G | G | F | N |
| Blade buckling | | | | |
| Prevention of Image | G | N | N | N |
| defects due to toner | | | | |
| slipping | | | | |

G: Good
F: Fair
N: No good

Referring to FIG. 8, in the case of the cleaning blades 8 and 57 in the first embodiment, the toner having slipped by the cleaning blade 8 at the transitional portion between the treated (hardened) portion 82 and untreated portion 83 of the blade 8 was removed by the untreated portion 83 of the cleaning blade 57. Referring to FIG. 2, the toner remaining on the intermediary transfer belt 54 after being transferred onto the intermediary transfer belt 54 from the photosensitive drum (1) was efficiently removed by the untreated portion 83 of the cleaning blade 57. Therefore, even after 150,000 copies were continuously made, the image forming apparatus 110 did not output a copy which is unsatisfactory in that the toner having slipped by the cleaning blades 8 and 57 is visible across the copy.

Next, referring to FIG. 1, the image forming apparatus 110 was structured so that as the intermediary transfer belt 54 is circularly moved, it is oscillated in its widthwise direction by the tilting of the steering roller 60. Therefore, as the intermediary transfer belt 54 was circularly moved, the toner having slipped by the cleaning blade 57, at the transitional portion between the treated (hardened) portion 82 and untreated (unhardened) portion 83 of the blade 57, was eventually removed by the treated (hardened) portion 82 or untreated portion 83. Therefore, no lines formed of toner were visible on the intermediary transfer belt 54.

### [First Comparative Image Forming Apparatus]

Referring to FIG. 6, in the case of the first comparative image forming apparatus, the untreated portion P of the cleaning blade 8 is the same in dimension in terms of the lengthwise direction of the cleaning blades 8 and 57 as the untreated portion Q of the cleaning blade 57, and also, the transitional portion between the untreated portion 83 (P) and treated portion 82 of the cleaning blade 8, coincides in position to the transitional portion between the untreated portion 83 (Q) and treated portion 82 of the cleaning blade 57, in terms of their lengthwise direction. Otherwise, the cleaning blades 8 and 57 of the first comparative image forming apparatus are the same in specification and manufacturing method, as the counterparts in the first embodiments. The cleaning blades 8 and 57 of the first image forming apparatus allowed a small amount of toner to slip by the blades 8 and 57, but did not buckled downstream. However, the small amount of toner having slipped by the cleaning blade 8 formed visible lines on the intermediary transfer belt 57, which were transferred onto a sheet P of recording medium. Consequently, the image forming apparatus 110 outputted unsatisfactory images. Thus, the first image forming apparatus were deemed unsatisfactory.

### [Second Comparative Image Forming Apparatus]

The second comparative image forming apparatus was created by replacing the cleaning blades 8 and 57 of the image forming apparatus in the first embodiment, with cleaning blades 8 and 57 which are different in specifications from those in the first embodiment. Referring to FIG. 6, in the case of the second comparative image forming apparatus, the untreated (unhardened) portion 83 (P) of the cleaning blade 8 of the drum cleaning device 7 was longer than the untreated (unhardened) portion 82 (Q) of the cleaning blade 57 of the belt cleaning device 56. Otherwise, the cleaning blades 8 and 57 of the second comparative image forming apparatus are the same in specification and manufacturing method, as the counterparts in the first embodiments.

The cleaning blades 8 and 57 of the second comparative image forming apparatus did not buckle downstream. However, they generated low frequency noises which are a precursor to the occurrence of the blade buckling. Further, during the latter half of the continuous image forming operation, it became impossible for the treated (hardened) portion 82 of the cleaning blade 57 to recover the residual toner on the intermediary transfer belt 57, that is, the toner having slipped by the cleaning blade 8 and transferred onto the intermediary transfer belt 57. Consequently, lines formed of the residual toner appeared on the intermediary transfer belt 54. Then, the lines formed of toner was transferred onto a sheet of recording medium, making the image forming apparatus 110 to yield an image which has unwanted lines formed of toner. Thus, the second comparative image forming apparatus were deemed unsatisfactory in image quality.

### [Third Comparative Image Forming Apparatus]

Referring to FIG. 6, also in the case of the third comparative image forming apparatus, the untreated portion 83 (P) of the cleaning blade 8 and the untreated portion 83 (Q) of the cleaning blade 57 were the same in dimension in terms of the lengthwise direction of the blades 8 and 57, and the transitional portion between the treated (hardened) portion 82 and untreated portion 83 of the cleaning blade 8 aligned with the transitional portion between the treated (hardened) portion 82 and untreated portion 83 of the cleaning blade 57 in terms of the moving direction the intermediary transfer belt 54. However, the isocyanate compounded was not left on the lengthwise end portions of the cleaning blade 57 as long as it was left on the lengthwise end portions of the cleaning blade 57 in the first embodiment. Therefore, the amount of the swelling of the lengthwise end portions of the cleaning edge portion of the cleaning blade 57 of the third comparative image forming apparatus was not as much as that in the first embodiment. More concretely, the length of time the isocyanate was allowed to react with the cleaning blade 57 after being applied to the blade 57 was 10 minutes, which is substantially shorter than 40 minutes in the first embodiment. Otherwise, the cleaning blades 8 and 57 of the third comparative image forming apparatus were the same in specification and manufacturing method as the counter parts in the first embodiment.

In the case of the third comparative image forming apparatus, the cleaning blade 8 allowed a minute amount of toner to slip by, but, the toner having slipped by the cleaning blade 8 was removed by the transitional portion between the treated (hardened) portion 82 and untreated portion 83 of the cleaning blade 57, each time it reached the cleaning blade 57. However, the cleaning blade 57 began to buckle downstream during the relatively early stage of the continuous image forming operation, that is, after the outputting of roughly 5,000 copies.

As described above, in the case of the cleaning blades 8 and 57 of the image forming apparatus in the first embodiment, the transitional portion between the treated (hardened) portion 82 and untreated portion 83 of the cleaning blade 8 is covered by the untreated portion 83 of the cleaning blade 57. Therefore, it does not that the toner having slipped by the cleaning blade 8 and been transferred onto the intermediary transfer belt 57 accumulates on the intermediary transfer belt 57. Therefore, not only does the image forming apparatus 101 not output a copy (image) having the unwanted lines attributable to the toner having slipped by the cleaning blades 8 and 57, but also, the cleaning blade 57 is prevented from buckling downstream. Therefore, the image forming apparatus in the first embodiment is enabled to continuously output high quality images for a long time.

### Embodiment 2

FIG. 9 is a schematic drawing for describing the positioning of the cleaning blade of the drum cleaning device in the second embodiment. Referring to FIG. 9, in the case of the image forming apparatus in the second embodiment, the transitional portion between the treated (hardened) portion 82 and untreated portion 83 of each of the cleaning blades 8Y, 8M, 8C and 8Bk in the image forming stations PY, PM, PC and PBk, respectively, does not coincide in position in terms of the lengthwise direction of the cleaning blades; it does not align with those of the other cleaning blades 8 in terms of the rotational direction of the photosensitive drums 1.

In the second embodiment, the image formation stations PY, PM, PC and PBk having photosensitive drums 1Y, 1M, 1C and 1Bk, and cleaning devices 7Y, 7M, 7C and 7Bk, respectively, are aligned along the intermediary transfer belt 54. The cleaning blades 8Y, 8M, 8C and 8Bk are different in the dimension of their unhardened portion, in terms of their lengthwise direction.

Referring to FIG. 9, among the four drum cleaning devices, the more downstream is a given cleaning device positioned relative to the other in terms of the toner image conveyance direction, the wider the unhardened portion of the cleaning device. The cleaning blades 8Y, 8M, 8C and 8Bk were manufactured so that they became different in the dimension of their lengthwise end portions treated with isocyanate. Therefore, they are different in the dimension of their untreated portion P. Therefore, in the second embodiment, the cleaning blades 8Y, 8M, 8C and 8Bk are different in the position of the transitional portion between their treated (hardened) portion 82 and untreated portion 83 in terms of their lengthwise direction. Therefore, the toner having slipped by the transitional portion between the treated (hardened) portion 82 and untreated (unhardened) portion of the cleaning blade 8 of an upstream belt cleaning device does not coincides in position with the transitional portion between the untreated (unhardened) portion and treated (hardened) portion of the cleaning blade 8 of a downstream belt cleaning device.

Therefore, even if each of the cleaning blades 8Y, 8M, 8C and 8Bk of the image forming stations PY, PM, PC and PBk, respectively, allows a minute amount of toner to slip by, the four bodies of toner having slipped by the cleaning blades 8Y, 8M, 8C and 8Bk, one for one, and been transferred onto the intermediary transfer belt 54 are different in their position on the intermediary transfer belt 54. Therefore, they can efficiently recovered by the cleaning blade 57.

Also in the second embodiment, the more downstream the image forming stations PY, PM, PC and PBk are among themselves, the greater they are in the dimension P of their untreated portion 83. Therefore, even if toner slips by the cleaning blade of the upstream cleaning device, is transferred onto the intermediary transfer belt 54, and is transferred onto the photosensitive drum in the downstream image formation station, this toner can be efficiently moved by the untreated portion 83 of the cleaning blade of the downstream image formation station. Therefore, the image forming apparatus in this embodiment is advantageous in terms of the residual toner removal performance, over an image forming apparatus structured so that the more downstream the image formation stations PY, PM, PC and PBk among themselves, the less in the dimension of their untreated portion P, and also, so that the toner having slipped by the cleaning blade 8 of an upstream image formation station is removed by the treated (hardened) portion 82 of the cleaning blade 8 of the downstream image formation station P.

### Embodiment 3

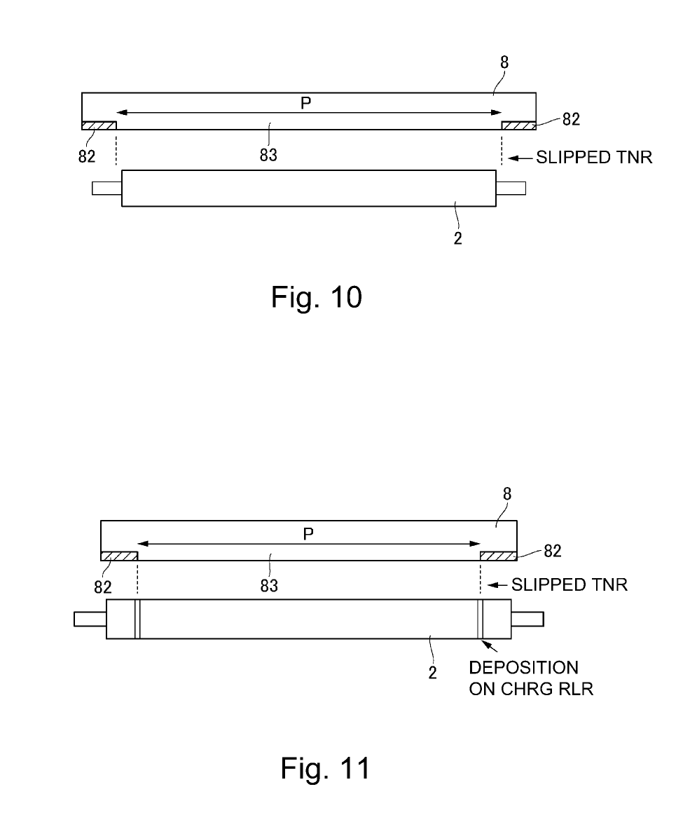

FIG. 10 is a schematic drawing for describing the positional relationship between the treated (hardened) portion 82 of the cleaning blade 8, and the charge roller 2, in the third embodiment. FIG. 11 is a schematic drawing for describing the positional relationship between the treated (hardened) portion 82 of the cleaning blade 8, and charge roller 2, of the fourth comparative image forming apparatus.

In the third embodiment, the dimension of the untreated portion 83 (P), that is, the portion between the treated (hardened) portions, of the cleaning blade 8 was made less than the dimension of the of the charge roller 2, in terms of the direction perpendicular to the toner image conveyance direction.

Referring to FIG. 7, the length of the charge roller 2 equals the dimension of the range C of the photosensitive drum 1, which is chargeable with the charge roller 2. The end of the range C is indicated by a referential code c, the width c-c of the range C is 319 mm. In comparison, the width d-d of the cleaning blade 8 of the drum cleaning device 7 is 327 mm, and the width L of each of the treated (hardened) end portions 82 is 3 mm. Therefore, the untreated portion 83 of the cleaning blade 8, that is, the portion of the cleaning blade 8 sandwiched by the treated (hardened) portions 82, is 321 mm, being 2 mm wider than the width c-c of the range C. Otherwise, the cleaning blades 8 and 57 in the third embodiment are the same in specification and manufacturing method as those in the first embodiment. Referring to FIG. 5, the length of time isocyanate was allowed to permeate into the cleaning blade 8 in this embodiment was 40 minutes, and the amount H by which they swollen was 35 μm as the cleaning blade 8 in the first embodiment.

### [Experiment for Evaluating Image Forming Apparatus for Residual Toner Removal Performance]

The cleaning blade 8 and 57 in the third embodiment, and cleaning blades 4, 5 and 6 of the fourth, fifth and sixth comparative image forming apparatuses, respectively, were tested under the same condition as that under which the cleaning blades 8 and 57 in the first embodiment were test. Then, they were evaluated using the same evaluation standard as that used for the cleaning blade 8 and 57 in the first embodiment. More specifically, the cleaning blades in the third embodiments, and cleaning blades of the fourth, fifth, and sixth comparative image forming apparatuses, which are different in specification were mounted in the image forming apparatus for testing cleaning blades, and 150,000 copies of an image, which is 5% in image ratio, were continuously outputted with the use of the apparatus under various conditions. Then, the copies were evaluated for the buckling of the cleaning blades 8 and 57. The results of the evaluation are given in Table 2.

TABLE 2

| | | Comp. | Comp. | Comp. |
|---|---|---|---|---|
| | Emb. 3 | Ex. 4 | Ex. 5 | Ex. 6 |
| Relation between | Charging | Charging | Charging | Charging |
| non-treated width | region C | region C | region C | region C |
| P of the blade | Non- | Non- | Non- | Non- |
| 8 and charging | treated | treated | treated | treated |
| region C width | width | width | width | width |
| Swelling width of | 35 | 35 | 35 | Non |
| blade 8 (micron) | | | | |
| Prevention of | G | G | G | N |
| Blade buckling | | | | |
| Prevention of Image | G | N | F | G |
| defects due to toner | | | | |
| slipping | | | | |

G: Good
F: Fair
N: No good

Referring to Table 2, in the case of the cleaning blades 8 and 57 in the third embodiment, even when the image forming apparatus outputted 150,000 copies, none of the copies showed any sign of defect attributable to the problem that the transfer residual toner slipped by the cleaning blades 8 and 57. Further, neither of the cleaning blade 8 and 57 buckled.

Referring to FIG. 10, the cleaning blade 8 in the third embodiment allows a minute amount of transfer residual toner on the photosensitive drum 1 to slip by. However, the portions of the cleaning blade 8, at which the toner slips by the cleaning blade 8, are outside the range of the charging roller 2 in terms of the lengthwise direction of the charge roller 2. Therefor, it does not occur that the transfer residual toner having slipped by the cleaning blade 8 adheres to the charge roller 2. Therefore, it does not occur that the adhesion of the residual toner from the photosensitive drum to the charge roller 2 causes the charge roller to unevenly charge the photosensitive drum. Therefore, it does not occur that the image forming apparatus outputs a defective image, the defects of which are attributable to the uneven charging of the photosensitive drum, which is caused by the adhesion of the residual toner to the charge roller.

### [Comparative Image Forming Apparatus 4]

Referring to FIG. 7, the width c-c of the charging range C of the charge roller 2 of the fourth comparative image forming apparatus is 319 mm. In comparison, the width d-d of the cleaning blade 8 of the drum cleaning device 7 is 327 mm, and the width L of each of the treated (hardened) portions 82 of the cleaning blade 8 is 6 mm. Therefore, the width P of the untreated portion of the cleaning blade 8 is 315 mm. Thus, the untreated portion of the cleaning blade 8 is 2 mm narrower than the charging range C of the charge roller 2, on each side of the cleaning blade 8 in terms of its lengthwise direction. Otherwise, the cleaning blade 8 of the fourth comparative image forming apparatus is the same in specification and manufacturing method as the cleaning blade in the first embodiment.

Referring to FIG. 11, in the case of the fourth comparative image forming apparatus, the cleaning blade 8 did not buckle. However, the toner having slipped by the cleaning blade 8 adhered to the charge roller 2. Consequently, the image forming apparatus began to output blemished images, the blemish of which is attributable to the uneven charging of the image formation range of the photosensitive drum, after the continuous outputting of 5,000 copies.

### [Comparative Image Forming Apparatus 5]

Referring to FIG. 7, also in the case of the fifth comparative image forming apparatus, the width c-c of the charging range C of the charge roller 2 is 319. In comparison, the width d-d of the cleaning blade 8 of the drum cleaning device 7 is 327 mm. The width L of each of the treated (hardened) lengthwise end portions 82 was 4 mm. Thus, the width P of the untreated portion of the drum cleaning blade 8 was 319 mm, which was the same as the width c-c of the charging range C. Otherwise, the cleaning blades 8 and 57 of the fifth comparative image forming apparatus are the same in specification and manufacturing method as the cleaning blades 8 and 57 in the first embodiment.

The cleaning blade 8 of the fifth comparative image forming apparatus did not buckle. However, the toner having slipped by the cleaning blade 8 adhered to the lengthwise end portions of the charge roller 2. Consequently, a phenomenon that the edge portions of a sheet of recording medium in terms of the direction perpendicular to the recording medium conveyance direction are soiled by toner, began to occur after the continuous outputting of 10,000 copies.

### [Comparative Image Forming Apparatus 6]

The lengthwise end portions (82) of the cleaning blades 8 and 57 of the sixth comparative image forming apparatus were not treated with isocyanate. That is, they were not hardened. In other words, the entirety of the cleaning edge portion of the cleaning blades 8 and 57 was an untreated portion 83.

The cleaning blade 8 of the sixth comparative image forming apparatus did not have an area equivalent to the transitional portion between the treated (hardened) portion 82 and untreated portion 83 of a cleaning blade treated with isocyanate. Therefore, it did not allow residual toner to slip by, and therefore, the charge roller 2 was not contaminated with the residual toner. Therefore, the image forming apparatus did not output blemished images, the blemishes of which are attributable to the contamination of the charge roller 2 by the residual toner. However, when the image forming apparatus was operated in the high temperature-high humidity environment (32.5° C., 80%), which is a very sever environment with respect to the blade buckling, the blade 8 began to buckle, starting from its lengthwise end portion, after the continuous outputting of 20,000 copies.

### Embodiment 4

Not only is a combination of the drum cleaning device and belt cleaning device in accordance with the present invention is applicable to an image forming apparatus employing an intermediary transfer belt, but also, an image forming apparatus employing a recording medium conveyance belt.

In the case of the image forming apparatus in the fourth embodiment, as the recording medium conveyance belt, which is an example of recording conveying means, conveys a sheet of recording medium through the secondary transfer station, a toner image is transferred onto the sheet of recording medium from the photosensitive drum. The image forming apparatus is equipped with a drum cleaning device, which is positioned right next to the photosensitive drum, and the cleaning blade (first cleaning blade) of which is placed in contact with the peripheral surface of the photosensitive drum. Further, the image forming apparatus is equipped with a belt cleaning device, which is positioned immediate adjacencies of the recording medium conveyance belt, and the cleaning blade (second cleaning blade) of which is placed in contact with the recording medium conveyance belt.

In order to reduce the lengthwise end portions of the first and second cleaning blades in the friction between themselves and the surface to be cleaned by the blades, the lengthwise end portions of both the first and second cleaning blades were increased in hardness through the hardening process which also makes the processed portions to swell. Further, the image forming apparatus was structured so that the portion of the first cleaning blade, which was not increased in hardness, falls within the range of the portion of the second cleaning blade, which was not increased in hardness, in terms of the direction perpendicular to the toner image conveyance direction.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 053948/2012 filed Mar. 12, 2012 which is hereby incorporated by reference.

What is claimed is:

1. An image forming apparatus comprising:
a rotatable image bearing member for carrying a toner image;
a rotatable intermediary transfer member onto which the toner image is transferred from said image bearing member;
a transfer member for transferring the toner image from said intermediary transfer member onto a recording material;
a first cleaning blade for cleaning said image bearing member after the toner image is transferred onto said intermediary transfer member, wherein said first cleaning blade includes first regions and a second region with respect to a widthwise direction perpendicular to a rotational moving direction of the image bearing member, said first regions being at opposite end portions of said first cleaning blade, respectively and having a first hardness, and said second region being between said first regions and having a hardness which is lower than the first hardness; and
a second cleaning blade for cleaning said intermediary transfer member after the toner image is transferred onto the recording material, wherein said second cleaning blade includes third regions and a fourth region with respect to the widthwise direction, said third regions being at opposite end portions of said second cleaning blade, respectively and having a second hardness which is the same as or different from the first hardness, and said fourth region being between said third regions and having a hardness which is lower than the second hardness, and wherein said second region is within the fourth region with respect to the widthwise direction.

2. An apparatus according to claim 1, further comprising a charging roller for charging said image bearing member in a predetermined region with respect to the widthwise direction, wherein said second region is within the predetermined region, and the predetermined region is within the fourth region.

3. An apparatus according to claim 1, further comprising a developing roller for developing said image bearing member in a predetermined region with respect to the widthwise direction, wherein the predetermined region is within the fourth region.

4. An image forming apparatus comprising:
rotatable first and second image bearing members for carrying toner images;
a rotatable intermediary transfer member onto which the toner images are transferred from said first image bearing member and said second image bearing member;
a first cleaning blade for cleaning said first image bearing member after the toner image is transferred onto said intermediary transfer member, wherein said first cleaning blade includes first regions, a second region, a first transitional portion and a second transitional portion with respect to a widthwise direction perpendicular to a rotational moving direction of the first image bearing member, said first regions being at opposite end portions of said first cleaning blade, respectively and having a first hardness, and said second region being between said first regions and having a hardness which is lower than the first hardness, wherein said first transitional portion being between one of said first regions and said second region, and said second transitional portion being between the other of said first regions and said second region; and
a second cleaning blade for cleaning said second image bearing member after the toner image is transferred onto said intermediary transfer member, wherein said second cleaning blade includes third regions, a fourth region, a third transitional portion corresponding to said first transitional portion and a fourth transitional portion corresponding to said second transitional portion with respect to a widthwise direction perpendicular to a rotational moving direction of the second image bearing member, said third regions being at opposite end portions of said second cleaning blade, respectively and having a second hardness which is the same as or different from the first hardness, and said fourth region being between said third regions and having a hardness which is lower than the second hardness, wherein said third transitional portion being between one of said third regions and said second region, and said fourth transitional portion being between the other of said first regions and said second region, and wherein positions of said first transitional portion and said third transitional portion are different from each other with respect to the widthwise direction, wherein positions of said second transitional portion and said fourth transitional portion are different from each other with respect to the widthwise direction.

5. An apparatus according to claim 4, wherein said second image bearing member is disposed downstream of said first image bearing member with respect to a rotational moving direction of the intermediary transfer member, and a region between said first transitional portion and said second transitional portion is in a region between said third transitional portion and said fourth transitional portion.

6. An apparatus according to claim 1, wherein said first cleaning blade is integrally formed of rubber elastic material, and second cleaning blades is integrally formed of the rubber elastic material, and hardnesses of said first and third regions are made higher than said second and fourth regions, respectively by a hardening treatment by application of isocyanate cross-linking agent and heat treatment.

7. An apparatus according to claim 6, wherein a step is formed between a portion subjected to said hardening treatment and a portion not subjected to said hardening treatment by swelling of the portion subjected to said hardening treatment relative to the portion having subjected to said hardening treatment.

8. An image forming apparatus comprising:
an image bearing member for bearing a toner image;
a recording material feeding member for carrying and feeding a recording material;
a transfer member for transferring the toner image from said image bearing member onto the recording material fed by said recording material feeding member;
a first cleaning blade for cleaning said image bearing member after the toner image is transferred onto the recording material, wherein said first cleaning blade includes first regions and a second region with respect to a widthwise direction perpendicular to a feeding direction of the recording material, said first regions being at opposite end portions of said first cleaning blade, respectively and having a first hardness, and said second region being between said first regions and having a hardness which is lower than the first hardness; and
a second cleaning blade for cleaning said recording material feeding member after the toner image is transferred onto the recording material, wherein said second cleaning blade includes third regions and a fourth region with respect to the widthwise direction, said third regions being at opposite end portions of said second cleaning blade, respectively and having a second hardness which is the same as or different from the first hardness, and said fourth region being between said third regions and having a hardness which is lower than the second hardness, and wherein said second region is within said fourth region with respect to the widthwise direction.
